(19) United States
(12) Patent Application Publication
(10) Pub. No.: US 2020/0327597 A1
(43) Pub. Date: Oct. 15, 2020

(54) PRODUCT EVALUATION SYSTEM AND METHOD

(71) Applicant: Oppobot Oy, Helsinki (FI)

(72) Inventors: Heli Maria HOLTTINEN, Helsinki (FI); Veli-Pekka JULKUNEN, Espoo (FI)

(73) Assignee: Oppobot Oy, Helsinki (FI)

(21) Appl. No.: 16/380,410

(22) Filed: Apr. 10, 2019

(51) Int. Cl. G06Q 30/06; G06Q 30/02; G06Q 10/06

(52) U.S. Cl. CPC G06Q 30/0629; G06Q 10/06393; G06Q 30/0201

(57) ABSTRACT

Systems and methods are disclosed for collecting information on product data related to a product to form a cumulative database, processing the collected information to form product features, calculating values to the product features, processing the values of the product features to compare at least one value of a product feature to a model value to form at least one comparison value, and evaluating the at least one comparison value on basis of information in the cumulative database to form enhancement data for the product.

### FIELD

The present disclosure generally relates to evaluating customer touch points throughout a customer lifetime, such as product and service concepts, packaging designs, marketing communications, and their possibilities to succeed in the target market.

### BACKGROUND INFORMATION

A central part of evaluation is concept testing. Concept testing can refer to qualitative or quantitative research among the target audience in order to identify appeal of the tested concept and business viability. Concept testing can be conducted as a survey when respondents evaluate concepts reflectively. Additionally, survey-based concept testing can include methods, such as face recognition, to capture unreflective reaction, such as emotions and eye movements.

Known testing methods can suffer from certain drawbacks. For example, concept testing takes a long time and is expensive because these projects involve many market researcher workdays and the use of, for example, consumer or B2B panels. As a consequence, testing can be made too seldom and too late, which can preclude knowing failing risks early enough. In addition, the process is unsystematic, and therefore the companies do not learn enough from their own or others' success stories or mistakes. As a result, companies too often launch incomplete products, services and campaigns that create too little value for customers and also for themselves.

Known digital survey tools are all-terrain research tools, which has severe downsides in helping companies to create and launch winning concepts and customer touchpoints in general. As they are used for all types of surveys beyond concept testing, they do not systematically gather a database of successful and unsuccessful concept test results. Nor do they have machine learning capabilities in place to help companies create winning concepts. As a result, they are unable to provide concept-related key performance indicators (KPIs), company or industry benchmarks and recommendations to improve concepts. For example, they lack focus and capabilities to provide companies with an instant, reliable and cost-efficient recipe for success.

### SUMMARY

A product evaluation system is closed comprising: a collection unit configured for collecting information on product data related to a product to form a cumulative database; a feature unit configured for processing collected information to form product features; a value unit configured for calculating values to the product features; a comparison unit configured for processing values of product features to compare at least one value of a product feature to a model value to form at least one comparison value; and an enhancement unit configured to evaluate the at least one comparison value based on information in the cumulative database to form enhancement data for the product.

A product evaluation method is also disclosed comprising: collecting information on product data related to a product to form a cumulative database; processing the collected information to form product features; calculating values to the product features; processing the values of the product features to compare at least one value of a product feature to a model value to form at least one comparison value; and evaluating the at least one comparison value based on information in the cumulative database to form enhancement data for the product.

### BRIEF DESCRIPTION OF THE DRAWINGS

Exemplary, non-limiting embodiments of the present disclosure and their advantages are explained in greater detail below with reference to the accompanying drawings, in which:

FIG. 1 presents an exemplary known evaluation system;

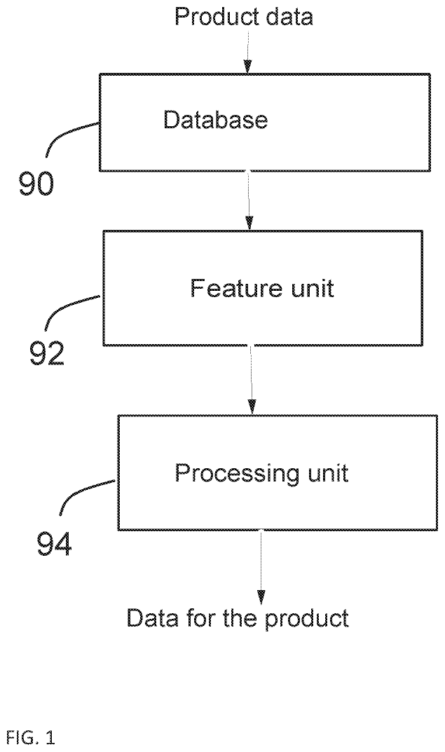

FIG. 2 presents a product evaluation system according to an exemplary embodiment of the present disclosure; and

FIG. 3 presents an exemplary product evaluation method according to the present disclosure.

### DETAILED DESCRIPTION

The following discussion is provided for a basic understanding of the disclosed invention and aspects of various embodiments as described herein. The following disclosure presents concepts used in exemplary embodiments of the present disclosure.

The term “product” as used in the specification refers, for example, to evaluating all kinds of customer touchpoints throughout the customer journey, such as product and service concepts, packaging designs, marketing communication, and their possibilities to succeed in the target market, based on data which is gathered during a concept testing survey and which is stored in the database. During the survey respondents can evaluate concepts reflectively and/or unreflectively. Additionally, the survey-based concept testing can include methods, such as face recognition, to capture unreflective reaction, such as emotions and eye movements.

Exemplary embodiments described in the present disclosure relate to a system and a method for providing companies with an instant, valid, reliable and cost-efficient digital tool, such as a Saas platform, to know early on success possibilities of their products.

Exemplary embodiments as described in the present disclosure include a product evaluation system having a collection unit that collects information on product data related to a product to form a cumulative database, a feature unit that processes the collected information to form product features, a value unit that calculates values to the product features, a comparison unit that processes the values of the product features to compare at least one value of a product feature to a model value to form at least one comparison value, and an enhancement unit that evaluates the at least one comparison value on basis of information in the cumulative database to form enhancement data for the product.

Exemplary embodiments described in the present disclosure also include a product evaluation method for collecting information on product data related to a product to form a cumulative database, processing the collected information to form product features, calculating values to the product features, processing the values of the product features to compare at least one value of a product feature to a model value to form at least one comparison value, and evaluating the at least one comparison value based on information in the cumulative database to form enhancement data for the product.

Exemplary embodiments described herein can be based on collecting information on product data related to a product to form a cumulative database, and on processing the collected information to form product features. Exemplary embodiments may be further based on calculating values to the product features, on processing the values of the product features to compare at least one value of a product feature to a model value to form at least one comparison value, and on evaluating the at least one comparison value on basis of information in the cumulative database to form enhancement data for the product.

An exemplary benefit of embodiments described herein is allowing for creating winning concepts even globally by making the product evaluation process digital, automated, and thus easy, fast, cheap, systematic and even self-learning.

The embodiments described herein can save time and money and allow for and/or make better-informed decisions and thus launch more successful products and services. Exemplary embodiments can allow a smart artificial intelligence (AI) assisted concept creation tool that provides its users with reliable recipe possibilities for success even instantly and very cost-efficiently. All this can be achieved without known methods of conducting new surveys among a target audience, such as a consumer panels or by enhancing such methods. This is possible by using the accumulated database of different concept tests and using this data to train an AI-system.

In addition, exemplary embodiments described herein can allow for creating and testing all sorts of products. Users may work with all pieces of customer experience throughout the service path in all touch points as multi-sensory experiences (e.g., using all senses). Users may work with all pieces of a customer experience that target customers and evaluate customer responses based on their reflective and unreflective responses, and their sense-based responses and emotions. Examples of ideas and concepts that can be created and tested in exemplary embodiments are: customer insights, consumer insights, value propositions, attributes, benefits, use occasion(s), packaging type, packaging size, packaging design, product type, product size, product design, interior design, service model, service path, brand information, concept name, pricing, graphical identity, logo, marketing information and advertising information.

When users test product data among a target audience, such as in external consumer and B2B panels or among their own respondents, the respondents evaluate products and/or product data both reflectively, unreflectively, and by using their senses and emotions. The respondents may provide their feedback or input to the product data by, for example, one or more of the following ways: answers or evaluations to all possible types of quantitative survey questions, scale questions, yes or no questions, single-select questions, multi-select questions, voice answers to a survey and other voice reactions such as content, tone-of-voice, and choosing the most attractive and unattractive parts or other specified parts of the product data item where the product data item can be, for example, text, image, video and numbers. Choices can be marked, for example, by using smileys and other types of symbols. Also, product data can be a written material provided by the respondent, such as open-ended answers.

Additionally, product data can be captured by analyzing unreflective reactions, such as facial expressions of respondents and eye movements of respondent. Exemplary embodiments can also use other external data sources as an input for analyses, forecasts and recommendations. These data sources can be for example client's financial data, such as sales data, external market data such as category development in terms of sales, any other external data relating to market conditions, such as publicly available data on weather conditions and any other external data relating to respondents such as a digital footprint. Data can also be collected with sensors, wearables etc. of the respondents when they see the product to be tested. All kinds of product data, internal or external, can be collected to a cumulative database to be utilized according to the exemplary embodiments described herein.

Exemplary embodiments can analyze target audience feedback, compare the feedback to earlier test results and thus provide the users with forecasts and recommendations even without any new survey efforts. This can be achieved by combining (AI) machine learning with a novel and cumulative database. Following are exemplary types of advice that can be provided to the user(s): Key performance indicators (KPI) forecasts which may include relevant concept testing KPIs, such as willingness to buy, willingness to use, uniqueness, understanding, relevance, credibility, liking, brand element with fit to the product data, such as brand fit, forecasts on hottest target groups, for example based on the key KPIs, and forecasts on hottest use occasions for example based on the key KPIs. Also, different demographic groups can be taken into account when forming product data. The user(s) can also be provided with evaluation information of tested product data components by options which give most increase to the likelihood of KPIs to achieve the best possible results, for example, attributes, benefits, packaging visuals and logos.

Furthermore, the user(s) can be provided with evaluation information of tested product data components such as informing which new elements to add which have not been a part of the original product data but which the product evaluation system recognizes to increase the KPIs to achieve the best possible results, for example recommendations to add new attributes, to change a color of the packaging, to add a claim to the packaging, etc.

The benefits of the exemplary embodiments can be achieved by using the accumulated database of different product data tests and by using the processed data to train an AI-system.

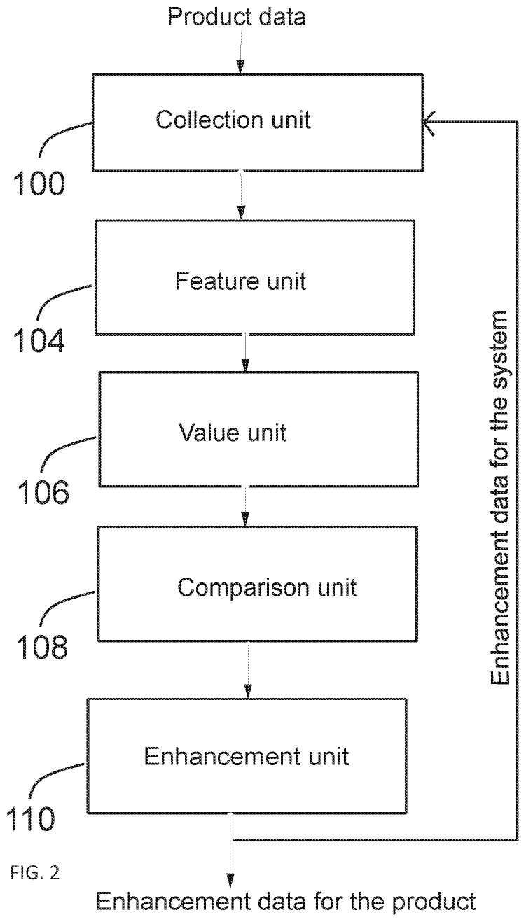

FIG. 2 presents an exemplary product evaluation system according to the present disclosure. The system includes a collection unit 100 that collects information on product data related to a product 102 to form a cumulative database, a feature unit 104 that processes the collected information to form product features, and a value unit 106 that calculates values to the product features. In an exemplary embodiment the collection unit 100 can be configured to collect information on product data from external data sources to the cumulative database.

The product data can include information on at least one of customer insight, consumer insight, value proposition, attribute, benefit, use occasion, packaging type, packaging size, packaging design, product type, product size, product design, interior design, service model, service path, brand information, concept name, pricing, graphical identity, logo, marketing information and advertising information.

The product evaluation system can include a comparison unit 108 that processes the values of the product features to compare at least one value of a product feature to a model value to form at least one comparison value, and an enhancement unit 110 that evaluates the at least one comparison value on basis of information in the cumulative database to form enhancement data for the product. In an exemplary embodiment the model value is a key performance indicators (KPI) value. The product evaluation system can be configured to learn independently based on the information collected to the cumulative database. The collected information may be for example enhancement data of the former analysis, so the product evaluation system can be configured to learn iteratively to form more and more prefect enhancement data for the product.

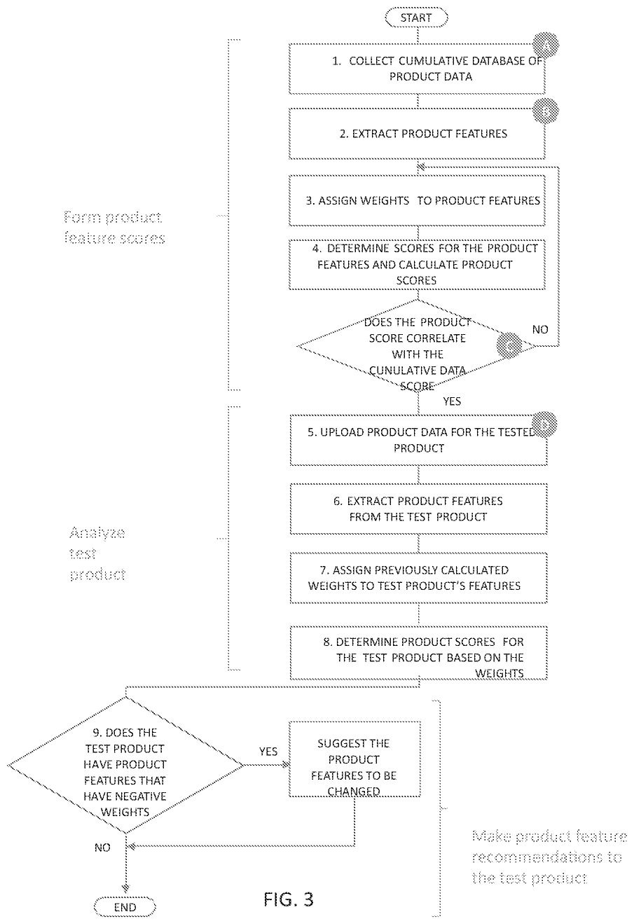

FIG. 3 presents an exemplary product evaluation method according to the present disclosure. In the method, product feature scores can be formed: 1) by collecting cumulative database of product data, 2) by extracting product features, 3) by assigning weights to product features, 4) and/or by determining scores for the product features and by calculating product feature scores.

Then it is determined whether the product feature score correlates with a reference data score in a cumulative database. If not, then the methods steps 3 and 4 are processed again. When yes, in a next method phase a test product can be analyzed: 5) by uploading product feature data for a product to be tested, 6) by extracting product features of the test product, 7) by assigning previously calculated weights to the test product's features, 8) and by determining product feature scores for the test product based on the assigned weights. In the following method phase, product feature recommendations are made to the test product 9) by determining whether the test product has product features that have negative weights. If yes, every such product feature is proposed to be changed. This can be performed, for example, based on the reference data in the cumulative database. If no, the test product has passed the test.

When correlating the exemplary method of FIG. 3 to the system of FIG. 2, method steps 1-4 can, for example, be performed in the collection unit 100, feature unit 104 and value unit 106. Method steps 5-8 can, for example, be performed in the comparison unit 108, and method step 9 can be performed in the enhancement unit 110.

In the following paragraphs, an exemplary numerical embodiment with tables is presented to demonstrate how the method of FIG. 3 can function: Products have features. In the simplified example shown herein, features are marked having a value of 1 when the product has the noted features, and features are marked as having a value of 0, when the product does not have the noted feature. Feature scores can be collected by using surveys in which consumers respond whether they agree with having the feature or not. In these surveys, AI algorithms can be utilized for example, if an image of a product indicates the product having the feature or not. The AI algorithms can be for example convolution neural networks or other off the shelf algorithms or via other methods or any combination of them e.g., Wolfram Mathematica by Wolfram, NGC by NVIDIA, Microsoft Cognitive Toolkit by Microsoft, Deep Learning Training Tool by Intel, or Neural Designer by Artelnics.

| | | | | | Product | Reference | |
|---|---|---|---|---|---|---|---|
| Product | Feature 1 | Feature 2 | Feature 3 | Feature 4 | score | score | Difference |
| Product 1 | 1 | 1 | 1 | 0 | 10 | 10 | 0 |
| Product 2 | 1 | 0 | 0 | 1 | 2.8 | 5 | 2.2 |
| Product 3 | 0 | 0 | 1 | 1 | 1.8 | 4 | 2.2 |
| Product 4 | 1 | 1 | 1 | 0 | 10 | 7 | 3 |
| Product 5 | 1 | 1 | 0 | 0 | 8 | 8 | 0 |
| Product 6 | 1 | 1 | 1 | 0 | 10 | 9 | 1 |
| Product 7 | 1 | 1 | 1 | 1 | 9.8 | 4 | 5.8 |
| Product 8 | 1 | 0 | 0 | 1 | 2.8 | 3 | 0.2 |
| Product 9 | 1 | 0 | 1 | 0 | 5 | 3 | 2 |
| Product 10 | 1 | 0 | 0 | 0 | 3 | 2 | 1 |
| Product 11 | 0 | 0 | 1 | 0 | 2 | 2 | 0 |
| Product 12 | 1 | 1 | 1 | 1 | 9.8 | 10 | 0.2 |
| | | | | | | | Sum of |
| | | | | | | | difference |
| | | | | | | | 17.6 |
| | Feature | Feature | Feature | Feature | | | |
| | score 1 | score 2 | score 3 | score 4 | | | |
| | 3 | 5 | 2 | −0.2 | | | |

In the next table, each of the features is assigned a score. Initially it can be a random score but through an iterative optimization process, an “optimal” feature score can be found for each feature. Optimal scores in this example can be found when comparing a reference score with a product score for each feature: Product score=feature1×feature score 1+ feature 2× feature score 2+ . . .

In this example Product10's product score is 3 because it has only one feature which score is 3 (feature 1).

In the iterative process we will find feature scores that minimize the overall difference between a product score and a reference score across all of the products. Also, maximization of the difference between the scores can be performed.

In a next phase a new product can be added. Its features can be extracted and a product score can be calculated based on the feature scores.

| | | | | | Product | Reference | |
|---|---|---|---|---|---|---|---|
| Product | Feature 1 | Feature 2 | Feature 3 | Feature 4 | score | score | Difference |
| Product 1 | 1 | 1 | 1 | 0 | 10 | 10 | 0 |
| Product 2 | 1 | 0 | 0 | 1 | 2.8 | 5 | 2.2 |
| Product 3 | 0 | 0 | 1 | 1 | 1.8 | 4 | 2.2 |
| Product 4 | 1 | 1 | 1 | 0 | 10 | 7 | 3 |
| Product 5 | 1 | 1 | 0 | 0 | 8 | 8 | 0 |
| Product 6 | 1 | 1 | 1 | 0 | 10 | 9 | 1 |
| Product 7 | 1 | 1 | 1 | 1 | 9.8 | 4 | 5.8 |
| Product 8 | 1 | 0 | 0 | 1 | 2.8 | 3 | 0.2 |
| Product 9 | 1 | 0 | 1 | 0 | 5 | 3 | 2 |
| Product 10 | 1 | 0 | 0 | 0 | 3 | 2 | 1 |
| Product 11 | 0 | 0 | 1 | 0 | 2 | 2 | 0 |
| Product 12 | 1 | 1 | 1 | 1 | 9.8 | 10 | 0.2 |
| | | | | | Product | Reference | |
| Product | Feature 1 | Feature 2 | Feature 3 | Feature 4 | score | score | Difference |
| Product 1 | 1 | 1 | 1 | 0 | 10 | 10 | 0 |
| Product 2 | 1 | 0 | 0 | 1 | 2.8 | 5 | 2.2 |
| Product 3 | 0 | 0 | 1 | 1 | 1.8 | 4 | 2.2 |
| Product 4 | 1 | 1 | 1 | 0 | 10 | 7 | 3 |
| Product 5 | 1 | 1 | 0 | 0 | 8 | 8 | 0 |
| Product 6 | 1 | 1 | 1 | 0 | 10 | 9 | 1 |
| Product 7 | 1 | 1 | 1 | 1 | 9.8 | 4 | 5.8 |
| Product 8 | 1 | 0 | 0 | 1 | 2.8 | 3 | 0.2 |
| Product 9 | 1 | 0 | 1 | 0 | 5 | 3 | 2 |
| Product 10 | 1 | 0 | 0 | 0 | 3 | 2 | 1 |
| Product 11 | 0 | 0 | 1 | 0 | 2 | 2 | 0 |
| Product 12 | 1 | 1 | 1 | 1 | 9.8 | 10 | 0.2 |
| | | | | | | | Sum of |
| | | | | | | | difference |
| | | | | | | | 17.6 |
| | Feature | Feature | Feature | Feature | | | |
| | score 1 | score 2 | score 3 | score 4 | | | |
| | 3 | 5 | 2 | −0.2 | | | |

The next table shows that because product 12 has a feature 4 which score is −0.2 it can be seen that by removing the feature, the product score would increase from 9.8 to 10. This could be for example a package of bread where removing an image of a man could improve the product score for the package.

| | | | | | Product | Reference | |
|---|---|---|---|---|---|---|---|
| Product | Feature 1 | Feature 2 | Feature 3 | Feature 4 | score | score | Difference |
| Product 1 | 1 | 1 | 1 | 0 | 10 | 10 | 0 |
| Product 2 | 1 | 0 | 0 | 1 | 2.8 | 5 | 2.2 |
| Product 3 | 0 | 0 | 1 | 1 | 1.8 | 4 | 2.2 |
| Product 4 | 1 | 1 | 1 | 0 | 10 | 7 | 3 |
| Product 5 | 1 | 1 | 0 | 0 | 8 | 8 | 0 |
| Product 6 | 1 | 1 | 1 | 0 | 10 | 9 | 1 |
| Product 7 | 1 | 1 | 1 | 1 | 9.8 | 4 | 5.8 |
| Product 8 | 1 | 0 | 0 | 1 | 2.8 | 3 | 0.2 |
| Product 9 | 1 | 0 | 1 | 0 | 5 | 3 | 2 |
| Product 10 | 1 | 0 | 0 | 0 | 3 | 2 | 1 |
| Product 11 | 0 | 0 | 1 | 0 | 2 | 2 | 0 |
| Product 12 | 1 | 1 | 1 | 1 | 9.8 | 10 | 0.2 |

Exemplary embodiments according to the present disclosure can utilize one or more of the following: statistical analysis, machine learning, AI and computer vision, natural language processing, speech-to-text analysis and classification done by humans), image and/or video sources for test image, cameras, mobile phones and wearables. Exemplary embodiments according to the present disclosure can also utilize one or more of the following: internet public sources (websites, stores, etc) and internet public sources (image data providers, etc). Other applications will be readily apparent to those skilled in the art.

The specific examples provided in the description given above should not be construed as limiting the scope and/or the applicability of the appended claims.

A system can include a hardware processor for implementing end module for performing the method, and thus the system may include one or more special purpose or general-purpose processor devices. Each hardware processor device may be connected to a communication infrastructure, such as a bus, message queue, network, multi-core message-passing scheme, etc. The network may be any network suitable for performing the functions as disclosed herein and may interface with a local area network (LAN), a wide area network (WAN), a wireless network (e.g., Wi-Fi), a mobile communication network, a satellite network, the Internet, fiber optic, coaxial cable, infrared, radio frequency (RF), or any combination thereof. Other suitable network types and configurations will be apparent to persons having skill in the relevant art.

A system may also include a memory for storing model-based information (e.g., random access memory, read-only memory, etc.). The memory may be read from and/or written to in a well-known manner. In accordance with an exemplary embodiment, the memory is a non-transitory computer-readable recording media (e.g., ROM, RAM hard disk drive, flash memory, optical memory, solid-state drive, etc.). A hardware processor device as discussed herein may be a single hardware processor or a plurality of hardware processors. Hardware processor devices may have one or more processor “cores.”

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. A product evaluation system comprising:
a collection unit configured for collecting information on product data related to a product to form a cumulative database;
a feature unit configured for processing collected information to form product features;
a value unit configured for calculating values to the product features;
a comparison unit configured for processing values of product features to compare at least one value of a product feature to a model value to form at least one comparison value; and
an enhancement unit configured to evaluate the at least one comparison value based on information in the cumulative database to form enhancement data for the product.

2. The product evaluation system of claim 1, where the model value is a key performance indicators (KPI) value.

3. The product evaluation system of claim 1, where the product data comprises:
information on at least one of customer insight, consumer insight, value proposition, attribute, benefit, use occasion, packaging type, packaging size, packaging design, product type, product size, product design, interior design, service model, service path, brand information, concept name, pricing, graphical identity, logo, marketing information or advertising information.

4. The product evaluation system of claim 1, where the collection unit is configured to collect information on product data from external data sources to the cumulative database.

5. The product evaluation system of claim 1, where the system is configured to learn independently based on information collected to the cumulative database.

6. A product evaluation method comprising:
collecting information on product data related to a product to form a cumulative database;
processing the collected information to form product features; calculating values to the product features;
processing the values of the product features to compare at least one value of a product feature to a model value to form at least one comparison value; and
evaluating the at least one comparison value based on information in the cumulative database to form enhancement data for the product.

7. The method of claim 6, where the model value is a key performance indicators (KPI) value.

8. The method of claim 6, where the product data is formed of information on at least one of customer insight, consumer insight, value proposition, attribute, benefit, use occasion, packaging type, packaging size, packaging design, product type, product size, product design, interior design, service model, service path, brand information, concept name, pricing, graphical identity, logo, marketing information or advertising information.

9. The method of claim 6, comprising:
collecting information on product data from external data sources to the cumulative database.

10. The method of claim 6, comprising:
performing independent learning based on basis information collected to the cumulative database.
